(19) United States
(12) Patent Application Publication
(10) Pub. No.: US 2005/0015256 A1
(43) Pub. Date: Jan. 20, 2005

(54) Method and apparatus for ordering food items, and in particular, pizza

(76) Inventor: James B. Kargman, Chicago, IL (US)

Correspondence Address: Howard E. Silverman;GREENBERG TRAURIG, LLP, Suite 2500, 77 West Wacker Drive, Chicago, IL, 60601, US

(21) Appl. No.: 10/856,234

(22) Filed: May 28, 2004

Related U.S. Application Data
(60) Provisional application No. 60/474,036, filed on May 29, 2003.

(51) Int. Cl. G10L 15/00

(52) U.S. Cl. 704/272

(57) ABSTRACT

A method is disclosed for designating toppings to be assembled on a pizza as well as their respective position on the pizza wherein an order entry terminal is provided for a customer to use to specify an order for a pizza, the terminal being connected to a point-of-sale system and includes a display screen, voice synthesis generator, microphone, speaker, voice recognition processor capable of detecting the customer's spoken words and microprocessor controller. The customer is prompted to enter an order by speaking words in a human voice and in turn an image of the pizza ordered is displayed to permit the customer to confirm the accuracy and submit the order into a point-of-sale system.

This application claims priority under 35 U.S.C. 119(e) of the filing date of U.S. Ser. No. 60/474,036.

### BACKGROUND OF THE INVENTION

1. Field of the Invention

The present invention relates to an improved method and apparatus for ordering food items such as pizza. The present method and apparatus includes voice recognition functionality incorporated into a telephone based order entry system and/or a point of sale system operating in a retail store setting at the order counter or at a stand-alone kiosk or terminal.

2. Background and the Prior Art

A pizza restaurant operating a carry-out and/or delivery business typically maintains a phone bank staffed by order takers who answer incoming telephone calls from customers calling to place an order for pizzas or other food items which they wish to be delivered to their location or made ready to be picked-up or eaten on premises.

In some restaurant operations, the order takers merely note the customer's order on a printed order form by handwriting the particular order or by checking off boxes on the preprinted form to designate the food items being ordered. In some cases, order takers may have access to a computer based point-of-sale order system where, using a visual display and/or user input device such as a keyboard or touch-screen, they are able to enter details into a computer system including both the customer's identifying information, such as a name, address and/or telephone number, as well as the food items being ordered. Computerized systems operate according to software programming which execute the order entry process and control the screen display, automatically calculate the total charge for the order and transmit the order automatically to the kitchen for preparation.

A modern pizza restaurant, and in particular most of the franchised system locations, incorporate a computerized point-of-sale system throughout the business. The system is used in connection with accepting a customer order, instructing the kitchen to prepare a given order, packing and labeling the order for delivery or pick-up. A printer, terminal and/or video screen at the “make-line” station in the kitchen serves to instruct the cook what food items to prepare. The make-line is the kitchen counter area where a pizza is prepared and the toppings applied before going into an oven. Another printer, terminal and/or video screen instructs the packer how to package the finished pizza. The cashier or wait staff may use a printer, terminal and/or video screen to initiate the order, print a customer check and collect payment.

One of the challenges in the food service industry is to take a customer's food order quickly and accurately and to efficiently transmit the order to the food preparation area in the kitchen toward preparation, cooking and ultimate delivery of the product to the customer. Food ordering presents unique challenges, not the least of which is the concentration of orders at peak hours. In the pizza delivery business, for example, it is common to find that over 20% of a restaurant's business will occur during just 5% of the restaurant daily hours of operation. This concentration of business has been previously handled in a variety of ways including call sequencers, where callers can listen to pre-recorded sales messages while waiting for an order taker to become available.

A further challenge is processing orders from customers who wish to take advantage of coupons and other promotional offers distributed or honored by the business. In a typical restaurant serving pizza, the customer is provided the opportunity to select from a list ingredients which particular toppings the customer wants placed on the pizza. Customers are further provided the opportunity to specify that certain toppings be placed on one-half of the pizza and other toppings be placed on the other half. Moreover, customers are typically offered the opportunity to designate not only the particular toppings, but also the quantity of toppings, usually as a multiple of the standard measure, e.g. such as by ordering a pizza with double pepperoni—all of which may further complicate the ordering process.

Customers have become quite creative when it comes to configuring pizza orders. Pizza toppings are no longer limited to the basic ingredients and increasingly include more and more ingredients and toppings, some unconventional, and even exotic. A given customer may place a relatively complex order in an attempt to meet the demands of all of the members of a family who are sharing the pizza. The typical prior art order entry system, be it paper or computerized, still presents a significant opportunity for error in the order taking process—errors which are typically not discovered until a customer receives delivery or returns home with a carry-out order. Errors in the order taking process can cost a restaurant both money and good will in having to replace incorrect orders and/or provide credits to be used on future purchases. Staffing, wait times, language barriers can all generate errors and lead to customer dissatisfaction.

The present invention provides a unique and useful method and apparatus for use in conjunction with a telephone based order taking system as well as a computerized point-of-sale system which facilitates the taking of standard and custom orders from customers.

The present invention, as will be shown, serves to eliminate the difficulties presented by the conventional order taking methods, and assures that pizzas, and other foods that consist of multiple options, are prepared correctly and consistently.

The present invention serves to permit the user to speak to a computerized voice recognition based system which allows the customer to audibly interact with the system to place an order by selecting desired ingredients and their placement on a pizza, use a coupon or take advantage of another promotional offer.

Voice recognition makes it possible for a customer to speak their food order preferences out loud toward having have their order entered directly into a computer based point-of-sale system. The system consists of a voice recognition processor for defining the food items that can be ordered, as well as the creation of packaged offers that shorten and guide the order process.

The customer's spoken order and/or instructions can be captured for replay within the restaurant by various kitchen employees to clarify any order entry ambiguities, suspected errors and/or otherwise obtain special customer messages.

The present invention may be used by customers who place a food order via telephone or via an on-line or web based voice over IP order entry system. In addition, in the context of the retail store environment, the present invention could be used both by store employees serving customers placing orders by phone or in person, or by customers themselves at self-service kiosks or terminals.

The first automated telephone ordering system for pizza restaurants was demonstrated in June 1987 at the National Pizza Show in Chicago. This system allowed users to order either by keyboard by pressing “1”, “2”, or “3”, or over the telephone by pressing the touch-tone numbers “1”, “2”, or “3”.

Since that time a number of companies have adapted technology such as speaker independent speech recognition to the task of pizza ordering. The limited vocabulary involved in ordering a pizza would appear at first to make such an application a good candidate for automated ordering. Indeed, for simple orders such as one “large pepperoni” this is true. However, many food and pizza orders are placed in response to special offers or combination deals, and these deals and prices are subject to market competitive forces, and change frequently. In addition, some individual stores may have 200 or more of their own special coupon offers, in addition to those offered by the national franchisor, and/or others may accept competitor's coupons for equivalent products. Human operators are easily able to adapt to these special offers, but until now coupon redemption/processing has had limited application in automated order systems.

The present system incorporates a method that accepts complex orders and variable orders, using a combination of offer definition tools, dynamic coupon printing tools, and phoneme specification methods to accurately and efficiently process coupons and promotions.

These and other desirable characteristics of the present invention will become apparent in view of the present specification and drawings.

### SUMMARY OF THE INVENTION

A method is disclosed for ordering a customizable food item using an automated order processing system. The automated system includes a voice receiver for receiving spoken words from a customer, a microprocessor-based controller including a voice recognition processor capable of recognizing the spoken words, and a voice emitter for sending spoken words to the customer. The method comprises the steps of prompting the customer to speak an order for the customizable food item in a narrative manner, receiving the customer's spoken words, detecting the customer's spoken words, parsing the detected spoken words into concepts comprising components defining a food order, confirming the accuracy of the customer's order, and entering the customer's order.

In a preferred embodiment of the invention, the customizable food item is pizza. The voice receiver and the voice emitter may comprise a telephone system interface. Alternatively, the voice receiver may comprise a microphone, and the voice emitter may comprise a speaker, both housed within a kiosk or terminal.

Also, in a preferred embodiment, the automated order processing system further includes a statistical database. The step of parsing the detected spoken words further includes the steps of looking up the detected spoken words in the statistical database to determine the probability of their use in association with an order for the customizable food item, and obtaining clarification from the customer when the probability of a spoken word's use in conjunction with an order for the customizable food item is low.

Moreover, in a preferred embodiment, the automated order processing system further includes an order history database. The step of prompting the customer to enter an order further includes the step of customizing a customer prompt based upon prior food orders placed by the same customer and recorded in the order history database.

Also, in a preferred embodiment, the customer's spoken words include a first spoken word and a second spoken word, and the step of detecting the first spoken word overlaps in time with the step of receiving the second spoken word. Moreover, the step of parsing the detected spoken word may also overlap in time with the step of detecting the customer's spoken words.

A method is also disclosed for accepting and processing coupons using an automated order processing system. This method includes the steps of providing to a potential customer a printed coupon having printed thereon an identifying code that when spoken by the customer is readily discernable to the voice recognition processor, and a corresponding alphanumeric code; prompting the customer to speak the identifying code; detecting the customer's spoken identifying code; retrieving the corresponding alphanumeric coupon code, and discount information associated with alphanumeric coupon code; and entering the discount information into the order processing system.

In a preferred embodiment, the identifying code comprises a common word in a spoken language. In another preferred embodiment, the identifying code comprises a sequence of letters, a sequence of numbers, or a sequence of both letters and numbers, and the step of detecting the customer's spoken identifying code further includes the step of discarding at least one predetermined portion of the sequence.

Yet another method is disclosed for ordering a customizable food item. This method comprises the steps of prompting the customer to speak a component of an order for the customizable food item; receiving the customer's spoken words; detecting the customer's spoken words; adding the detected spoken words to the customer's order; repeating the steps of prompting, receiving and detecting until a complete order is achieved; and entering the customer's order into the order processing system.

### BRIEF DESCRIPTION OF THE DRAWINGS

FIG. 1 of the drawings illustrates an in-store self service terminal or kiosk according to the present invention; and

FIG. 2 of the drawings illustrates the main functional blocks of the present invention.

### DETAILED DESCRIPTION OF THE DRAWINGS

While this invention is susceptible to embodiment in many different forms, there are shown in the drawings and will be described in detail herein several specific embodiments. The present disclosure is to be considered as an exemplification of the principle of the invention intended merely to explain and illustrate the invention, and is not intended to limit the invention in any way to embodiments illustrated.

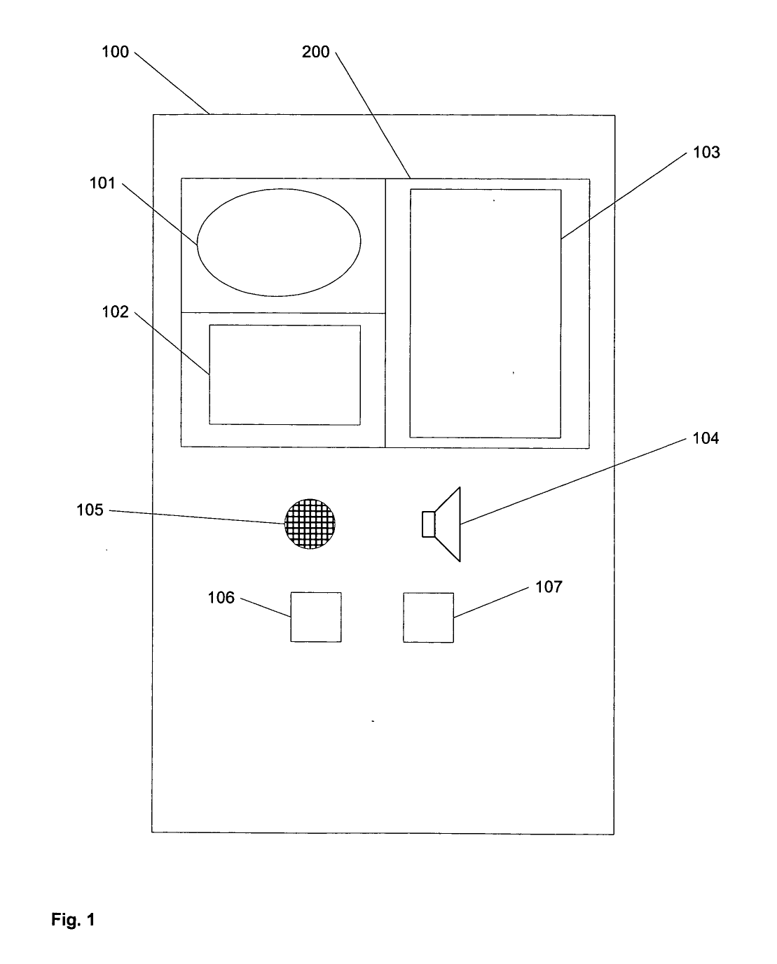

FIG. 1 of the drawings illustrates one embodiment of the present invention and specifically illustrates an in-store self-serve kiosk or terminal which permits a customer to place an order of a pizza or other food product. Kiosk or terminal 100 is shown including display screen 200. A similar terminal may be used in the kitchen area of the restaurant by store employees. In the embodiment illustrated, display screen 200 includes three distinct display areas, each of which display different content to the user or customer. Display area 101 is the region of display screen 200 which displays a photo-realistic image of the pizza or food item ordered by the customer. Display area 102 is the region of display screen 200 which displays a multi-color graphical user interface which may include a plurality of “buttons” which the user may press by physically contacting the screen proximate the button in the case of a touch-screen display, or by pointing and clicking with cursor control device, or by using the keyboard and pressing the key associated with a particular button. Display area 103 is the region of display screen which serves to present the user with optional information such as menu items, descriptions, advertised or unadvertised special offers etc.

The present invention may further incorporate a graphical user interface as disclosed in U.S. Provisional Patent Application Ser. No. 60/457,028, and U.S. patent application Ser. No. 09/949,389, the contents of which are incorporated herein by reference in their entirety.

Microphone 105 is provided for detecting the customer's spoken voice as further described below. Speaker 104 provides audio communication to the customer. Optionally, microphone 105 and speaker 104 can be embodied in a telephone style handset. Message light 106 is provided and which becomes lit to signal that a customer has stored an audible message for the restaurant in connection with the order being placed. Message play button 107 serves to play the message. It is envisioned that the kitchen could retrieve the customers audible order record by pressing button 107 even if light 106 were not lit.

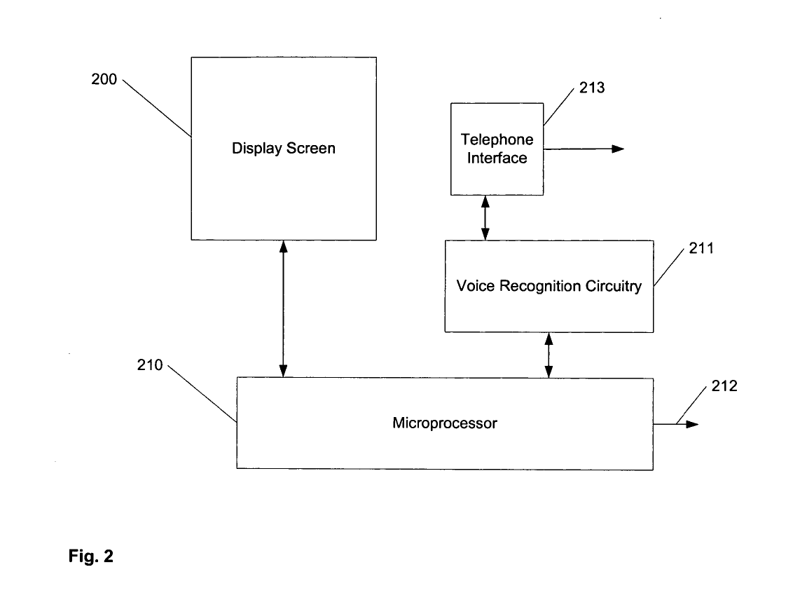

FIG. 2 of the drawings illustrates the main functional blocks of the present invention. Display screen 200 is connected to microprocessor 210. As described herein, display screen 200 may comprise a touch-screen enabled device. Speaker 104 and microphone 105 may be connected to a voice recognition processor 211 which is in turn connected to microprocessor 210, or as in the embodiment illustrated, a telephone line interface 213 serves to permit a customer to call into the system using the public switched telephone network. Microprocessor 210 is connected to a point of sale order processing system (not shown) via connection 212.

A kiosk or terminal based system operates as follows: The user or customer approaches the kiosk or terminal to place an order for pizza and/or other food items and speaks to the system using microphone 105. Microphone 105 may comprise a unidirectional microphone to minimize interference or may be integrated into an conventional telephone handset. The voice recognition processor accepts and reacts to the spoken commands of the consumer who audibly specifies the ingredients and their placement on a pizza. The system may initiate the order taking session by issuing a series of audible prompts or questions to the user to respond to in turn. For example, the system may initially audibly ask the user what size pizza the customer wishes to order. The system may optionally offer choices from which the user can select, by announcing the possible choice, e.g., small, medium and large. The system then detects the user's response.

This same interactive protocol may be used in connection with a dial-in system where a customer telephones a dedicated phone line to connect to an automated interactive voice recognition ordering system operated by or for the restaurant.

The order entry process begins with a customer placing a telephone call to the automated order entry system operated by the pizza restaurant. This hardware components of the system may be located within the restaurant and may serve just that facility, or may be shared by multiple facilities whereby orders are received at one location and in turn relayed to the location specified by the customer or the location identified by the system as being optimal for delivering food product to the customer.

Login Procedure

In one embodiment of the present invention it is presumed that the customer has previously registered with the order entry system whereby the customer's preferred delivery address and payment details are known to the system. The system can provide for automated registration of first time users or may require first time users to register manually by speaking with a human operator or using a separate system altogether.

In response to receiving a customer call, the automated order system may detect whether caller id data is available and if so whether the caller is recognized as being a registered user. If recognized, the system proceeds to process the order using the automated voice recognition system as described herein. If the customer record is not on file, the system can record the entire transaction including the customer spoken name and address information, and the record can be flagged so that the first available operator can transcribe this information and create a customer account and then process the recorded order. Alternatively, the customer is directed to a human operator if the caller id data is unavailable, the number is not recognized, or the customer otherwise indicates a desire to speak with a human.

In addition, if a customer is having a problem entering an order using the system, or they need to talk to a customer service representative (CSR) for some reason, the system insures that when the caller goes back into a call queue, they do not get picked up by the system again and are instead routed to a human CSR. Similarly, a customer may call back within a predetermined number of minutes of having placed an order using the system. It may be assumed that if a caller is calling back within a short period of time after placing an order that they are either requesting some information that the system can provide, such as estimated delivery time, or whether the pizza is in the oven, or has been dispatched to a driver or not. otherwise is either to change the order, cancel the order, make a complaint, all functions best handled by a live CSR, and not an automated system. The system may accordingly log the customer's phone number when they use the automated system and then restrict the system from answering another call from that customer for a specified period of time.

Greeting and Order Taking Mode

Upon being connected to the system the user will typically hear an audible greeting in pre-recorded or machine synthesized human speech which welcomes the user and initiates the order process. In a first embodiment, the order entry process is a lock-step process whereby the system poses one question at a time to the user in synthesized human speech and the customer responds, typically speaking short one or word responses which are easily recognized by the system. In this fashion the customer can be prompted step-by-step to configure a food order. As a specific example, the customer may be asked whether they wish to order “pizza”, “drinks” or “side items”. In response to the customer speaking the word “pizza” the system prompts the user to first specify the “size” by offering the customer the particular available options such as “large”, “medium” or “small”. After the customer responds, the system proceeds with the “ingredients” and then the “crust” options. The system may optionally forgo providing the user with additional prompts and may not announce each of the possible choices associated with each category, such as by announcing “large, medium or small” in connection with size, or announcing each of the available toppings in connection with “ingredients”.

When the customer finishes configuring the first food item the system prompts the user to either order another food item or place the order.

In an alternative and as a preferred embodiment the present system may prompt the user to provide their food order by speaking to the system in a narrative fashion, as opposed to answering discrete questions and responding in a lock-step manner. One particularly novel aspect of the present invention is indeed the ability to accept a narrative order from which the system may discern the various trigger “concepts” which make up a complete food order by accepting an analyzing a narrative string as opposed to single word responses. Instead of the customer providing responses to such prompts as, 1) what size pizza, 2) what toppings, 3) what crust, the system permits the user to speak in a natural voice and state, for example, “I'd like to order one large thin curst pepperoni pizza.” The system will detect the spoken string and parse the spoken words and decode that the customer has spoken the critical concepts which make up a complete order, namely, specifying quantity by speaking, “one”; size, “large”; toppings by speaking “pepperoni” and crust by speaking the word “thin”. The system will then repeat the order for the user's confirmation. The system can further detect and discern the individual concepts regardless of the order in which they were spoken. The customer could have easily spoken the phrase “one large pepperoni pizza, thin crust please”. In each case the system disregards words that do not relate to the concepts being detected and assembles the order from those concept words which it clearly detects.

Another particularly novel feature of the present invention is the use of a statistical database in combination with the voice recognition feature. The voice recognition functionality is provided by a software package which can be “programmed” for the individual application, namely a pizza restaurant. Such software is available from Lumenvox LLC of San Diego, Calif. The software operates by “scoring” the detected spoken phrases toward concluding what exactly the user said. Nevertheless, certain words may indeed “sound alike” to the software making it is more difficult to conclude with total accuracy what exactly was spoken by the customer. Individual speech patterns, accents etc can all affect the voice recognition process.

The aforementioned database is used to provide a further level of control and accuracy and assure that indeed a correct order is filled and mistakes are minimized. For example, a customer may order a pizza with pepperoni and mushroom. The words “mushroom” and “shrimp” may indeed sound alike to the system, and in some cases the system may determine that a pizza with pepperoni and shrimp was ordered. Yet statistically it is known that when a customer orders a pizza with pepperoni, it is much more likely that the second ingredient is “mushroom” and it is much less likely that it is “shrimp”. Accordingly when the system detects that a customer has ordered a combination pepperoni and shrimp the database can be used as a cross-check.

When a potential “mismatch” is detected, the system may operate in various modes to avoid a mistake. In one case, the system may simply ask the user to repeat the order. The system may speak the order back to the user for their confirmation. Alternatively, the system can prompt the user to dictate a narrative response which is recorded and captured by the system for later use, or the system may flag the order as one for which the spoken order should be retained for possible replay by the kitchen. As the present system is integrated into the point-of-sale system and kitchen of the restaurant, the pizza preparation area can be provided with a terminal upon which the order to be made is displayed. The cook will for example see a graphic and/or text display indicating that a large pepperoni is to be prepared. A signal such as a light on a terminal or display can also be provided to indicate to the make-line cook that an audio message accompanies the order. The cook may in turn activate the system to listen to the customer's own recording such that the cook may process the message and deal with any special instructions or otherwise insure that the order is correctly fulfilled.

On additional embodiment of the present invention makes novel use of a database which stores a given customer's order history. When a customer calls to place an order for food, drinks and/or side items, the system detects that the customer has an order history and looks to the history to identify that customer's prior orders and moreover the most popular items ordered. For example, the system may detect that the customer repeatedly orders a large pepperoni pizza and a large drink and/or never orders certain items. The system may proceed to generate an initial or supplemental prompt which is individually tailored for that particular customer. Moreover, the system may tailor the voice recognition “grammar” to that particular customer whereby more accurate, efficient and prompt order entry is accomplished.

Yet another embodiment of the present incorporates the concept of “pipelining” whereby the system takes advantage of a hardware/software platform having multi-processing capability. In practice most systems generate an audible prompt to the customer and then wait for a spoken response. After a predetermined wait period the system processes the customers spoken response. Only after such processing is completed does the system generate the next audible prompt to the customer. The present invention takes advantage of multiprocessing capabilities in a host computer by pipelining—instead of executing a double buffering methodology. In the present system the processing of any given step is spun off such that the system may begin to create another executable thread. In practice the customer no longer experiences a pause while the system processes the prior response. Instead, the system operates in a more natural interactive manner whereby prompts and responses are separated only by brief silence intervals. Because a given process has been spun off the system is free to accept a further response from the user. Once all of the parallel processing is completed the system may dynamically confirm the customer's order by, for example, asking the customer to repeat only that portion of the spoken order which was not received or is deemed otherwise suspect by the system. In short, only what the system missed is subject to follow-up with the customer. In this manner, customers experience a much more natural interaction with the order entry system. Customers are on and off the phone much faster.

One powerful aspect of this embodiment of the present invention is the lack of a lock-step flow of communication. A natural order entry experience is provided the user. If the user for example omits the crust type, the system detects that a concept is missing and can ask the customer to specify that and only that concept. In this manner customer acceptance and satisfaction are enhanced.

Preferably the automated voice recognition capabilities include North American English, with the ability to also support Spanish. It is further contemplated that automatic presentation of the customer-preferred language may be based on caller-ID linked to a previously specified language preference, or customer choice via touch-tone. Further, a speech interrupt (“barge in”) feature is provided that makes it possible for customers to make selections without being required to listen to the entire prompt or question.

Coupon Processing

The present system may further be used in an environment wherein coupons or special offers are accepted by a restaurant.

Accepting coupons using an automated interactive voice information system presents a challenge as some individual stores may have 200 or more of their own special coupon offers, in addition to those offered by the national franchisor. Moreover, a store or chain may accept a competitor's coupons for equivalent products. Human operators are easily able to adapt to these special offers, and until now coupon redemption/processing has had limited application in automated order systems.

According to the present invention, the restaurant can create coupon offers that include a variety of food item components and incorporates speech recognition components for each special offer. These recognition components include dynamically generated discardable syllables to facilitate continuous speech recognition in the entry of the special codes. The system makes it possible to recognize complex food orders as well as marketing coupon redemption information in much less time than previous methods.

The most direct way to process a coupon is to prompt the customer to enter a coupon code printed on the offer by speaking out loud. Unfortunately a coupon code typically comprises a mere string of alphanumeric characters. Voice recognition systems often have great difficulty recognizing individually spoken letters and number inasmuch as the letter “B” sounds much like the letter “D”. To permit efficient coupon processing it is preferable that coupon codes be selected to be easily recognized by an automated system and yet humans are not fond of having to read and then repeat lengthy alphanumeric sequences, particularly when a mistake results in a denial of an expected discount on a purchase.

To address the difficulties and potential customer reluctance to take advantage of coupons, the system preferably provides for the printing of a common word or phrase on the coupon which is easily pronounced and yet distinctive enough to be easily recognized by the voice recognition component of the present system. For example instead of an alphanumeric string, 148B4D, a coupon code might comprise the word “Montana”. Upon detecting this word the system will access a cross reference table which calls up the actual coupon code. This step is necessary since the present system interfaces with a store's existing point-of-sale system which may be independently programmed with coupon codes and their associated redemption values, values which change over time and by region, and further since the point-of-sale system is expecting an actual coupon code, not a short hand word or phrase.

Upon detecting a valid coupon the system is placed into a mode where it expects to receive a specific or a more complex order. Coupons or other special offers may offer a customer a fixed discount, such as $2.00 off one large pizza, or may offer a discounted combination offer, buy a second pizza for half price, or buy a pizza and receive a free drink of your choice. The system in one mode may directly announce to the customer that the coupon they are redeeming entitles them to a given benefit, e.g., they are entitled to a second pizza free. The customer then knows up-front that they are to order two pizzas. Alternatively, the benefit afforded by the coupon need not be announced up-front. In either case, If the system detects that the customer has neglected to place a “complete” order by having omitted ordering a second item when included as part of the promotion, the system can prompt the customer to specify the balance of the order that the coupon entitles the customer to place. If the coupon entitles the customer to a free drink, the system can prompt the customer to order a drink if the customer neglects to do so himself.

Alternatively, where codes are required or necessary, the system provides for the embedding of auto-discrimination discardable components in coupon offers to make the recognition process faster. A coupon code might be CMPNK where M and N are automatically embedded throwaway terms designed to assure that the codes C P K are recognized more quickly to speed the recognition process.

The foregoing description and drawings merely explain and illustrate the invention and the invention is not limited thereto, as those skilled in the art who have the disclosure before them will be able to make modifications and variations therein without departing from the scope of the invention.

1. A method for ordering a customizable food item using an automated order processing system having a voice receiver for receiving spoken words from a customer, a microprocessor based controller including a voice recognition processor capable of recognizing the spoken words, and a voice emitter for sending spoken words to the customer, the method comprising the steps of:
prompting the customer to speak an order for the customizable food item in a narrative manner;
receiving the customer's spoken words;
detecting the customer's spoken words;
parsing the detected spoken words into concepts comprising components defining a food order;
confirming the accuracy of the customer's order; and
entering the customer's order into the order processing system.

2. The invention according to claim 1 wherein the customizable food item is pizza.

3. The invention according to claim 1 wherein the voice receiver and the voice emitter comprise a telephone system interface.

4. The invention according to claim 1 wherein the voice receiver comprises a microphone and the voice emitter comprises a speaker, the microphone and speaker being housed within a kiosk or terminal.

5. The invention according to claim 1 wherein the automated order processing system further includes a statistical database, and the step of parsing the detected spoken words further includes the steps of:
looking up the detected spoken words in the statistical database to determine the probability of their use in association with an order for the customizable food item; and
obtaining clarification from the customer when the probability of a spoken word's use in conjunction with an order for the customizable food item is low.

6. The invention according to claim 1 wherein the automated order processing system further includes an order history database, and the step of prompting the customer to enter an order further includes the step of customizing the customer prompt based upon prior food orders placed by the same customer and stored in the order history database.

7. The invention according to claim 1 wherein the customer's spoken words include at least a first spoken word and a second spoken word, and wherein the step of detecting of the first spoken word overlaps in time with step of receiving the second spoken word.

8. The invention according to claim 1 wherein the step of parsing the detected spoken words overlap in time with the step of detecting the customer's spoken words.

9. A method for accepting and processing coupons using an automated order processing system having a voice receiver for receiving spoken words from a customer, a microprocessor based controller including a voice recognition processor capable of recognizing the spoken words, and a voice emitter for sending spoken words to the customer, the method comprising the steps of:
providing a printed coupon to a potential customer, the coupon having printed thereon an identifying code that when spoken by the customer is readily discernable to the voice recognition processor, and a corresponding alphanumeric code;
prompting the customer to speak the identifying code;
detecting the customer's spoken identifying code;
retrieving the corresponding alphanumeric coupon code, and discount information associated with the corresponding alphanumeric coupon code from an associated database; and
automatically entering the discount information into the order processing system.

10. The invention according to claim 9 wherein the identifying code comprises a common word in a spoken language.

11. The invention according to claim 9 wherein the identifying code comprises a sequence of letters, a sequence of numbers, or a sequence of both letters and numbers, and the step of detecting the customer's spoken identifying code further includes the step of discarding at least one predetermined portion of the sequence toward enhancing the automatic voice recognition of the code when spoken by the user.

12. The invention according to claim 9 wherein the customizable food item is pizza.

13. The invention according to claim 9 wherein the voice receiver and the voice emitter comprise a telephone system interface.

14. The invention according to claim 9 wherein the voice receiver comprises a microphone and the voice emitter comprises a speaker, the microphone and speaker being housed within a kiosk or terminal.

15. A method for ordering a customizable food item using an automated order processing system having a voice receiver for receiving spoken words from a customer, a microprocessor based controller including a voice recognition processor capable of recognizing the spoken words, and a voice emitter for sending spoken words to the customer, the method comprising the steps of:
prompting the customer to speak a component of an order for the customizable food item;
receiving the customer's spoken words;
detecting the customer's spoken words;
adding the detected spoken words to the customer's order;
repeating the steps of prompting, receiving, and detecting until a complete order is achieved; and
entering the customer's order into the order processing system.

16. The invention according to claim 15 wherein the customizable food item is pizza.

17. The invention according to claim 15 wherein the voice receiver and the voice emitter comprise a telephone system interface.

18. The invention according to claim 15 wherein the voice receiver comprises a microphone and the voice emitter comprises a speaker, the microphone and speaker being housed within a kiosk or terminal.
